(19) United States
(12) Patent Application Publication
(10) Pub. No.: US 2026/0167323 A1
(43) Pub. Date: Jun. 18, 2026

(54) ELECTRICAL FLIGHT CONTROL SYSTEM FOR CONTROLLING AN AIRCRAFT AND ASSOCIATED AIRCRAFT

(71) Applicant: AIRBUS HELICOPTERS, Marignane Cedex (FR)

(72) Inventors: Clément LETONNELIER, La Fare Les Oliviers (FR); Pascal IZZO, Berre L'etang (FR); Constance LAUBY, Aix En Provence (FR)

(73) Assignee: AIRBUS HELICOPTERS, Marignane Cedex (FR)

(21) Appl. No.: 19/404,683

(22) Filed: Dec. 1, 2025

(30) Foreign Application Priority Data
Dec. 12, 2024 (FR) FR2413950

(51) Int. Cl. B64C 13/50

(52) U.S. Cl. CPC B64C 13/503; B64C 13/505

(57) ABSTRACT

An electrical flight control system for controlling an aircraft, the flight control system comprising at least one subassembly for acquiring a piloting command in order to acquire the piloting command from an operation of an associated piloting member that can be operated by a pilot of the aircraft along at least one piloting axis, the flight control system comprising at least three position sensors per piloting axis generating position information of the piloting member and being in communication with the at least one acquisition subassembly. Each acquisition subassembly comprises at least three simplex computers each having a single calculation channel connected to one of the at least three position sensors.

### CROSS REFERENCE TO RELATED APPLICATION

This application claims priority to French patent application No. FR 24 13950 filed on Dec. 12, 2024, the disclosure of which is incorporated in its entirety by reference herein.

### TECHNICAL FIELD

The present disclosure relates to an electrical flight control system for controlling an aircraft and to an aircraft equipped with such a system.

### BACKGROUND

aircraft may comprise moving aerodynamic control surfaces controlled by an electrical flight control system in order to steer the aircraft. Such aerodynamic control surfaces may comprise rotor blades, propeller blades, ailerons or rudders for example.

An electrical flight control system may comprise a plurality of subassemblies for acquiring a piloting command, in order to acquire this command from an operation of an associated piloting member that can be operated by a pilot and/or a copilot of the aircraft.

Each flight control acquisition subassembly may be fully or partially incorporated in a piloting member that can be operated by a pilot. Such a piloting member that can be operated by a pilot may in particular comprise a moving part, such as a stick, a mini-stick or a lever, articulated relative to a support. Moreover, the flight control system also comprises a processing subassembly determining a positional setpoint to be reached in order to position one or more aerodynamic control surfaces in the required manner as a function of at least one command generated by a subassembly for acquiring the piloting command and the current situational state of the aircraft. Such a positional setpoint may be a pitch angle of a blade, a deflection angle of a flap or a speed of rotation of a rotor or a propeller, for example. Finally, the flight control system comprises at least one actuating subassembly controlling an actuator acting on one or more aerodynamic control surfaces as a function of a positional setpoint determined by the processing subassembly.

The first aircraft with electrical flight control comprised an electrical flight control system arranged in parallel with an emergency mechanical flight control system to allow manual landing in the event of failure of the electrical flight control system. Although effective, such an architecture may have the disadvantage of being heavy and bulky.

Alternatively, an aircraft may comprise an electrical flight control system with a high level of availability and reliability so as not to require mechanical redundancy.

For such a flight control system, certification regulations impose a failure occurrence rate less than or equal to 10⁻⁹/flight-hour, that leads to a failure occurrence rate less than or equal to 10⁻¹⁰/flight-hour for each subassembly.

In particular, an electrical flight control system may comprise one or more position sensors generating piloting member position information and being in communication with an acquisition subassembly.

In this context, a conventional acquisition subassembly may comprise a plurality of acquisition computers making it possible to acquire the commands generated according to the various control axes of the piloting member.

Each acquisition computer is also a synchronous duplex computer and has two calculation channels each connected to one of the position sensors of this control axis.

The expression “duplex computer” refers here and hereinafter to a computer that has two independent calculation channels, the execution of which is synchronized, unlike a simplex computer that has only one calculation channel. The expression “calculation channel” refers to a digital and/or analog processing unit that makes it possible to perform calculations on quantities represented digitally and/or analogically. The processing unit can perform digital processing with a processor or other forms of integrated circuit including logic circuits. The processing unit may perform analog processing with analog components integrated or not in integrated circuits such as, for example, operational amplifiers. The term “processor” may refer equally to a central processing unit or CPU, a graphics processing unit or GPU, a digital signal processor or DSP, a microcontroller, etc. For example, a duplex computer may comprise two calculation channels each having a processor, whereas a simplex computer comprises a single calculation channel having, for example, one processor.

A synchronous duplex computer comprises a calculation channel hereinafter referred to as a “command calculation channel” used to generate the desired output, and a calculation channel hereinafter referred to as “monitoring calculation channel” responsible for monitoring the operation of the command calculation channel in parallel and invalidating it if a fault is detected.

Document WO2023/209335 A1 does not belong to the technical field due to describing a system comprising two control members, one control member intended to be actuated by a pilot and the other intended to be actuated by the co-pilot.

These control members make it possible to control a collective pitch of the blades of a rotorcraft rotor. Each control member is equipped with two motors, so that the force feedback applied to each control member can be controlled both by a control unit specific to this control member and by another remote control unit using a communication bus.

Such an architecture having subassemblies comprising synchronous duplex computers may prove to be bulky.

In addition, equipment of the subassemblies of an electrical flight control system of an aircraft may be part of a Master Minimum Equipment List (MMEL). This list defines the list of equipment that may be inoperative for the flight, the conditions to be met to allow a flight in accordance with the objectives of the certification authorities and the number of days or hours of flight authorized from the discovery of the failure. This additional condition gives rise to other constraints and, in particular, leads to the attainment of a failure occurrence rate for the flight control system that is less than or equal to a value of between 10⁻⁷ and 10⁻⁸/flight-hour with a failed reference item of equipment, i.e., a failure occurrence rate of the subassemblies that is less than or equal to a value of between 10⁻⁸ and 10⁻⁹/flight-hour with a failed reference item of equipment. It should be noted that an item of equipment for which the failure occurrence probability is less than an acceptability threshold, typically 10⁻⁵/flight-hour, is not considered. In other words, it is accepted that the failure of an item of equipment having a failure rate below the acceptability threshold leads to immobilization of the aircraft.

Consequently, each subassembly must therefore have a failure occurrence rate of 10⁻¹⁰/flight-hour under normal conditions and, where applicable, of 10⁻⁸ to 10⁻⁹/flight-hour under MMEL conditions, namely if the flight is authorized for a certain number of flight-hours in the event of failure of a reference item of equipment of the subassembly.

Document U.S. Pat. No. 5,694,014A1 relates to a fly-by-wire type of electrical control system that incorporates redundant monitoring and incorporates manual control to enable the piloting of an aircraft.

Position and torque sensors monitor the movements of the manual control and deliver input signals to a force feedback generator.

Position sensors then deliver position signals to quad-redundant primary flight controllers. These primary flight controllers can thus form an acquisition subassembly comprising three or four controllers each having a single calculation channel connected to one of the three or four position sensors.

Document US 2024228023A1, for its part, discloses fly-by-wire (FBW) servoactuators for the primary flight control of aircraft, comprising servoactuators with integrated flight control computers (FCC).

In addition, a rudder pedal sensor unit may comprise a first position sensor and a second position sensor. The first position sensor may be different from the second sensor, and each position sensor may be coupled to a respective processing channel. A first processing channel may also be different from the processing channel.

Document US 20110108673A1 describes an electronic control device for the operation of a piloting member, referred to as a controlled piloting member, of an aircraft piloting device comprising two piloting members connected to at least one same driving member of the aircraft. This electronic operation control device comprises inputs for receiving signals delivered by sensors associated with one of the piloting members and electronic circuits for digitally processing the signals received on the inputs.

Document U.S. Pat. No. 8,761,969B2 relates to a flight control system present in an aircraft. The flight control system has a control module for transmitting commands to a plurality of actuators.

### SUMMARY

Therefore, one object of the present disclosure is to provide an innovative electrical flight control system.

The disclosure thus relates to an electrical flight control system for controlling an aircraft, the flight control system comprising at least one subassembly for acquiring a piloting command in order to acquire this piloting command from an operation of an associated piloting member that can be operated by a pilot of the aircraft along at least one piloting axis, the flight control system comprising at least three position sensors per piloting axis, each position sensor generating position information of the piloting member and being in communication with said at least one acquisition subassembly, each acquisition subassembly comprising at least three simplex computers each having a single calculation channel connected to one of said at least three position sensors.

In this system, at least two computers among said at least three simplex computers are dissimilar and at least two position sensors among said at least three position sensors are dissimilar.

Therefore, each simplex computer of such an acquisition subassembly typically has a failure occurrence rate less than or equal to 10⁻⁴/flight hour, that results in a failure occurrence rate less than or equal to 10⁻¹⁰/flight hour under normal conditions for this subassembly.

In addition, the at least two computers of each acquisition subassembly may comprise at least one so-called “primary” computer and at least one so-called “secondary” computer that are dissimilar, that contributes to obtaining the desired failure occurrence rates by taking into consideration the probability of occurrence of a common mode failure.

The dissimilarities are “physical” dissimilarities, for example through the use of different component suppliers, different PCB manufacturers or the like, and “software” dissimilarities, for example through different sets of instructions, different algorithms, different programming languages, or the like.

In order to improve the dissimilarities, the links with the other subassemblies of each of the primary and secondary computers of a subassembly can follow different routes within the aircraft to avoid common failure modes.

Such an acquisition subassembly can also meet the constraints related to the MMEL conditions as explained below.

Thus, each acquisition subassembly can have a failure occurrence rate of less than 10⁻¹⁰/flight hour, while having an optimized dissimilarity level, or even an optimized cost and/or footprint. Such an acquisition subassembly can then make it possible to optimize the cost, volume, and/or mass of the system, in particular because of the use of simplex computers.

The electrical flight control system may also comprise one or more of the following features, taken individually or in combination.

In practice, the flight control system may comprise at least two motors configured to jointly apply a force law to a moving part of said piloting member.

Such motors are controlled by the at least three simplex computers of the corresponding acquisition subassembly.

These motors thus enable a force to be generated on the moving part of the piloting member when this moving part is moved by a pilot of the aircraft relative to a support. Such piloting members are generally referred to as “assets”. In addition, it is then possible to modify the characteristics of the force law, such as a force gradient, damping, inertia or implementing of a stop, using a closed-loop servo-control of the at least two motors.

Such motors may be identical or dissimilar.

In a first variant of the control system, said at least three simplex computers may comprise two identical simplex primary computers and identical simplex secondary computers, dissimilar to the two simplex primary computers.

The terms “primary” and “secondary” in the expressions “primary computer” and “secondary computer” are used to distinguish the two dissimilar types of simplex computers. The expressions “simplex primary computer” and “simplex secondary computer” may be replaced respectively by “simplex computer of a first type” and “simplex computer of a second type”.

According to a first embodiment of the first variant, said at least two motors may comprise four motors, two motors being individually connected to two simplex primary computers via two control connections and two other motors being individually connected to two simplex secondary computers via two other control connections so as to be able to receive a control signal representative of the force law to be applied to the moving part of the piloting member, each motor being connected either to two primary monitoring connections of the two simplex primary computers, or to two secondary monitoring connections of the two simplex secondary computers in order to be able to emit a monitoring signal representative of a motor state.

In this first example, each motor is thus controlled by a dedicated simplex computer but is monitored by two simplex computers of the same type.

This architecture allows each simplex computer to cut off the motor control of the other simplex computer of the same type.

Identical simplex computers communicate with each other to harmonize the controlled force laws and to prevent the motors from generating opposing forces opposite to each other.

In contrast to the prior art, the disclosure thus proposes an active architecture with the use of four identical motors and four simplex computers, that are dissimilar in pairs, with the implementation of a COM/MON type architecture in these simplex computers. This architecture allows each simplex computer to generate both control instructions COM in order to generate a first command in a conventional manner, for example a force law to be applied by one motor and by executing monitoring instructions MON to monitor a force law to be applied by another motor.

This architecture therefore has a more optimized footprint, meets the constraints of dissimilarity and is compatible with the reliability constraints of the function under MMEL conditions.

According to a second embodiment of the first variant, said at least two motors may comprise:
a first motor connected to a first control connection of a first simplex primary computer in order to be able to receive a first control signal representative of the force law to be applied to the piloting member;
a second motor connected to a second control connection of a second simplex primary computer in order to be able to receive a second control signal representative of the force law to be applied to the piloting member; and
a third motor connected on command either to a first control connection of a first simplex secondary computer or to a second control connection of a second simplex secondary computer, in order to be able to receive a third control signal representative of the force law to be applied to the piloting member.

In this case, the various simplex computers no longer operate according to a COM/MON type architecture as in the first embodiment of the first variant. The simplex computers can, however, self-monitor through a hardware monitoring (HM) building block. Such a building block can then be simple to implement and be incorporated in each of the simplex computers.

Each simplex primary computer always controls one motor. On the other hand, the third motor may be controlled by one or other of the simplex secondary computers in order to improve the availability of the subassembly for acquiring a pilot command.

This second example of the first variant has the advantage of being less bulky compared to the first example, due to the elimination of one motor.

Such a hardware monitoring building block may be implemented by a continuous test method generally referred to by the expression “Continuous Build In Test” (CBIT). Such a CBIT method is then secured, for example with an independent power supply and/or a watchdog and a check preformed of the consistency of the motor control and a motor position.

In this case, the first motor may be connected to two first primary monitoring connections of the first simplex primary computer so as to be able to emit a first monitoring signal representative of a motor state of the first motor, the second motor may be connected to two second primary monitoring connections of the second simplex primary computer so as to be able to emit a second monitoring signal representative of a motor state of the second motor, and the third motor may be connected both to two first secondary monitoring connections of the first simplex secondary computer and to two second secondary monitoring connections of the second simplex secondary computer so as to be able to emit a third monitoring signal representative of a motor state of the third motor.

More precisely, one of the first two primary monitoring connections is connected to a first hardware monitoring building block of the first simplex primary computer. Thus, the first two primary monitoring connections are independent.

Similarly, one of the two second primary monitoring connections is connected to a second hardware monitoring building block of the second simplex primary computer and the two second primary monitoring connections are independent.

One of the first two secondary monitoring connections is connected to a third hardware monitoring building block of the first simplex secondary computer. Thus, the two first secondary monitoring connections are independent.

Similarly, one of the two second secondary monitoring connections is connected to a fourth hardware monitoring building block of the second simplex secondary computer and the two second secondary monitoring connections are independent.

Moreover, the third motor is electrically connected to a switching device, the switching device being electrically connected to the first simplex secondary computer and to the second simplex secondary computer and being configured to connect the third motor either to the first simplex secondary computer or to the second simplex secondary computer, the first simplex secondary computer and the second simplex secondary computer being self-monitored and communicating a first validity signal and a second validity signal respectively, firstly, to a first switch and a second switch connected in series and, secondly, to a third switch and a fourth switch connected in series with the switching device.

Such a control switching may be carried out, for example, by means of relays forming the first, second, third and fourth switches, or other types of system.

In the case corresponding to this first variant of the control system, said at least three position sensors may comprise two identical primary position sensors and two identical secondary position sensors dissimilar to the two primary position sensors.

For example, the two primary position sensors may be selected according to a first technology and the two secondary position sensors may be selected according to a second technology different from the first technology.

These first and second different technologies can be chosen from Hall effect position sensors, electromagnetic transducer or “resolver” type sensors, or Rotary Variable Differential Transformer (RVDT) type sensors.

In a second variant of the control system, said at least three simplex computers may comprise a simplex primary computer, a simplex secondary computer and a simplex tertiary computer, that are all mutually dissimilar.

This second variant has the advantage of being less bulky than the first variant since it only incorporates three motors and three simplex computers.

Each simplex computer comprises a hardware “HM” monitoring building block so that each of the computers can control one motor and monitor another motor and make a position acquisition using a dedicated sensor.

This architecture can be described as triplex, making it the most compact architecture. A complete dissimilarity at the level of the computers makes it possible to eliminate the common fault mode on these computers.

According to a third variant of the control system, said at least three simplex computers may comprise two identical simplex primary computers, two identical simplex secondary computers that are dissimilar to the two simplex primary computers and two identical simplex tertiary computers that are dissimilar to both the two simplex primary computers and the two simplex secondary computers.

This third variant thus comprises six simplex computers, dissimilar three by three. These six computers do not have a COM/MON architecture, nor an architecture equipped with a so-called “HM” hardware monitoring building block.

However, a vote can be made at the level of each motor to decide which computer will control and monitor that motor.

This architecture has the advantage of having only two motors, and ensuring a high level of availability due to the three simplex computers for one motor.

In this variant, each of the motors is controlled by three processing units of three different primary, secondary and tertiary channels. The actual control of each motor is carried out by a vote on the three controls. The position sensors are also defined by three different channels.

In a case corresponding to the second or third variant of the control system, said at least three position sensors may comprise a primary position sensor, a secondary position sensor dissimilar to the primary position sensor and a tertiary position sensor that is dissimilar to both the primary position sensor and the secondary position sensor.

More precisely, the primary position sensor may be selected from a first technology, the secondary position sensor may be selected from a second technology that is different from the first technology, and the tertiary position sensor may be selected from a third technology that is different from the first technology and the second technology.

These first, second and third different technologies can be chosen from Hall effect position sensors, electromagnetic transducer or resolver type sensors, or rotary variable differential transformer (RVDT) type sensors.

In practice, the acquisition subassembly may be incorporated in the piloting member.

More precisely, this acquisition subassembly may be integrated into the piloting member as a control stick for a collective pitch or a cyclic pitch of the blades of a rotorcraft rotor or propeller.

Thus, in the case where the piloting member is a control stick of a collective pitch, the latter then enables the aircraft to be controlled along one axis and the control system then comprises three position sensors making it possible to determine a position of the moving part with respect to the support of the piloting member.

On the other hand, when the piloting member is a control stick of a cyclic pitch, it then enables the aircraft to be controlled along two axes, a pitch axis and a roll axis, and the control system then comprises three position sensors for the pitch axis and three position sensors for the roll axis. These six position sensors thus make it possible to determine a position of the moving part relative to the support of the piloting member.

Another object of the present disclosure is an aircraft provided with an electrical flight control system for controlling the aircraft.

In such an aircraft, the flight control system is as described above.

In practice, such an aircraft can be a rotorcraft and comprises an electrical flight control system for controlling a collective pitch or a cyclic pitch of the blades of a rotorcraft rotor or propeller.

### BRIEF DESCRIPTION OF THE DRAWINGS

The disclosure and its advantages appear in greater detail from the following description of examples given by way of illustration with reference to the accompanying figures, wherein:

FIG. 1 is a schematic view of an aircraft having an electrical flight control system according to the disclosure;

FIG. 2 is a schematic view of an electrical flight control system according to a first embodiment of a first variant according to the disclosure;

FIG. 3 is a schematic view of an electrical flight control system according to a second embodiment of the first variant of the disclosure;

FIG. 4 is a schematic view of an electrical flight control system according to a third embodiment of the first variant according to the disclosure;

FIG. 5 is a schematic view of a switching device of FIG. 4 according to the disclosure;

FIG. 6 is a schematic view of an electrical flight control system according to a second variant according to the disclosure; and

FIG. 7 is a schematic view of an electrical flight control system according to a third variant according to the disclosure.

### DETAILED DESCRIPTION

Elements present in more than one of the figures are given the same references in each of them.

As already mentioned, the disclosure relates to an aircraft equipped with an electrical flight control system for controlling this aircraft.

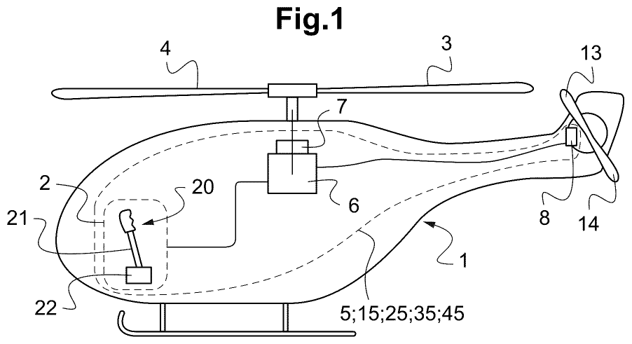

As shown in FIG. 1, such an aircraft 1 may be in the form of a rotorcraft comprising at least one rotor 3, 13 for controlling the lift and/or propulsion of this aircraft 1.

More generally, the aircraft 1 may comprise moving aerodynamic control surfaces 4, 14 controlled by an electrical flight control system 5, 15, 25, 35, 45 in order to steer the aircraft 1. Such aerodynamic control surfaces 4, 14 may comprise rotor blades 3, 13 propeller blades, ailerons or rudders for example.

Such a flight control system 5, 15, 25, 35, 45 then comprises at least one subassembly 2 for acquiring a piloting command produced by a pilot or co-pilot of the aircraft 1.

Such an acquisition subassembly 2 thus makes it possible to acquire this piloting command by moving an associated piloting member 20 that can be operated by the pilot of the aircraft 1 along at least one piloting axis.

Such a piloting member 20 may, for example, be in the form of a stick or a mini stick, enabling control of a cyclic pitch of the blades, or in the form of a lever enabling control of a collective pitch of the blades.

The piloting member 20 then comprises a movable part 21 having at least one degree of movement relative to a support 22. Each acquisition subassembly 2 thus makes it possible to generate an encoded command corresponding to a position of the moving part 21 according to each degree of movement of this moving part 21.

The electrical flight control system 5, 15, 25, 35, 45 comprises a processing subassembly 6 generating at least one positional setpoint, to be reached by one or more aerodynamic control surfaces 3, 13 as a function of at least one command encoded by the one or more acquisition subassemblies 2, the piloting command and the current situational state of the aircraft 1.

In addition, such a flight control system 5, 15, 25, 35, 45 also comprises at least one actuating subassembly 7, 8 controlling an actuator acting directly or indirectly on one or more aerodynamic control surfaces 3, 13 as a function of a positional setpoint determined by the processing subassembly 6.

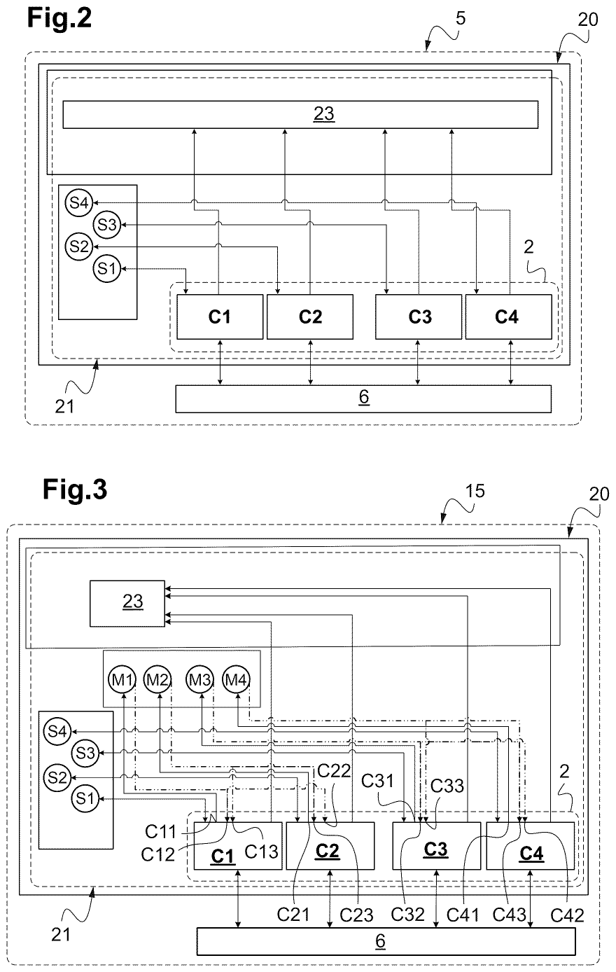

As shown in FIGS. 2 to 7, such a flight control system 5, 15, 25, 35, 45 then comprises at least three position sensors S1, S2, S3, S4, S1′, S2′, S3′ per control axis, each position sensor S1, S2, S3, S4, S1′, S2′, S3′ generating position information of the piloting member 20 and being in communication with the one or more acquisition subassemblies 2.

Furthermore, each acquisition subassembly 2 comprises at least three simplex computers C1, C1′, C1″, C2, C2′, C2″, C3, C3′, C3″, C4, C4″, C5″, C6″, each having a single calculation channel connected to one of said at least three position sensors S1, S2, S3, S4, S1′, S2′, S3′.

In addition, at least two computers C1, C1′, C1″, C2, C2′, C2″, C3, C3′, C3″, C4, C4″, C5″, C6″ among said at least three simplex computers C1, C1′, C1″, C2, C2′, C2″, C3, C3′, C3″, C4, C4″, C5″, C6″ are dissimilar and at least two position sensors S1, S2, S3, S4, S1′, S2′, S3′ among said at least three position sensors S1, S2, S3, S4, S1′, S2′, S3′ are dissimilar.

Thus, according to a first exemplary embodiment of a first variant, and as shown in FIG. 2, an acquisition subassembly 2 may comprise two identical simplex primary computers C1, C2 and two identical simplex secondary computers C3, C4 dissimilar to the two simplex primary computers C1, C2.

In addition, such an acquisition subassembly 2 may advantageously be integrated into the piloting member 20 and more precisely into the support 22 of this piloting member 20.

Each simplex computer C1, C2, C3, C4 receives input data from a respective set of position sensors S1, S2, S3, S4.

Indeed, the flight control system 5 comprises four position sensors S1, S2, S3, S4, each position sensor S1, S2, S3, S4 generating position information of the piloting member 20 and being in communication with the acquisition subassembly 2.

In practice, the four position sensors S1, S2, S3, S4 may comprise two identical primary position sensors S1, S2 and two identical secondary position sensors S3, S4 dissimilar to the two primary position sensors S1, S2.

The term “sensor” should be understood to mean a physical sensor capable of directly measuring the parameter in question, but also a system that may comprise one or more physical sensors, as well as means for processing the signal that make it possible to provide an estimation of the parameter based on the measurements provided by these physical sensors. Similarly, the notion of measuring parameters refers to both a raw measurement from a physical sensor and a measurement obtained by relatively complex processing of raw measurement signals.

In addition, at least one push button 23 of the pulse type may also be fitted to the piloting member 20. Information relating to a pressed state or a released state of each push button 23 can be generated alternately by successively pressing and then releasing a push button 23. Such information is then transmitted to the various simplex computers C1-C4 before being transmitted to the processing subassembly 6.

According to a second exemplary embodiment of the first variant as shown in FIG. 3, in addition to the position sensors S1-S4 and the simplex computers C1-C4, the flight control system 15 may comprise at least two identical motors M1, M2, M3, M4 configured to jointly apply a force law to the moving part 21 of the piloting member 20. Such motors M1, M2, M3, M4 then make it possible to activate the piloting member 20.

More precisely, the system 15 may comprise four motors, these motors M1, M2, M3, M4 being respectively connected, via a control connection C11, C21, C31, C41, to the simplex computers C1, C2, C3, C4 in order to be able to receive a control signal representative of said force law to be applied to the moving part 21 of the piloting member 20.

Furthermore, the first motor M1 may be connected to two primary monitoring connections C12, C22 of the two simplex primary computers C1, C2 in order to transmit to them a monitoring signal representative of a motor state.

Similarly, the second motor M2 may be connected to two primary monitoring connections C13, C23 of the two simplex primary computers C1, C2 in order to transmit to them a monitoring signal representative of a motor state.

The third motor M3 may be connected to two secondary monitoring connections C32, C42 of the two simplex secondary computers C3, C4 in order to transmit to them a monitoring signal representative of a motor state.

Finally, the fourth motor M4 can be connected to two other secondary monitoring connections C33, C43 of the two simplex secondary computers C3, C4 in order to transmit to them a monitoring signal representative of a motor state.

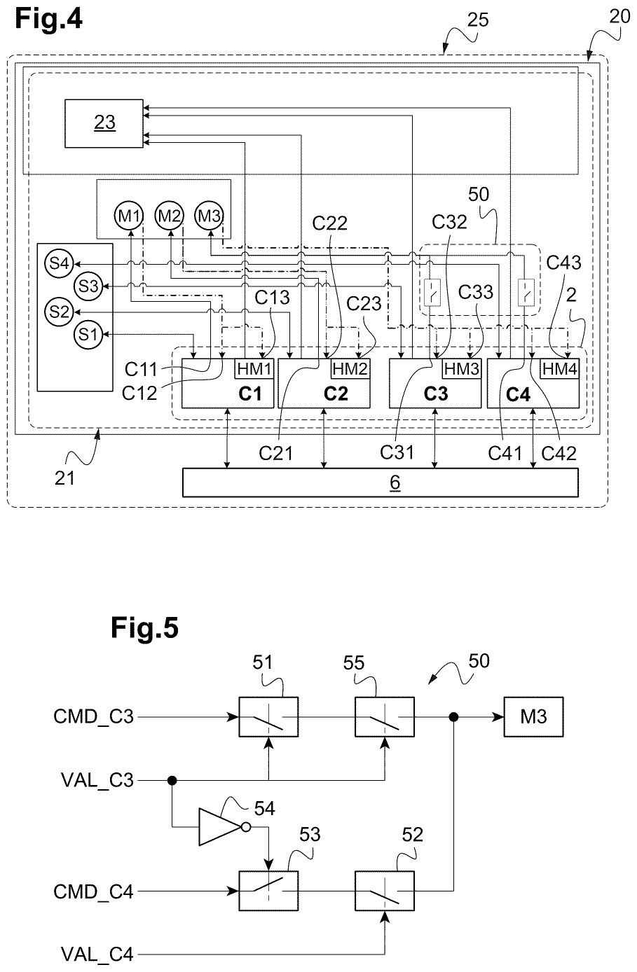

According to a third exemplary embodiment of the first variant as shown in FIG. 4, the system 25 may comprise three motors M1, M2, M3 connected to two simplex primary computers C1, C2 and two simplex secondary computers C3, C4.

Thus, a first motor M1 can be connected to a first control connection C11 of a first simplex primary computer C1 in order to be able to receive a first control signal representative of the force law to be applied to the piloting member 20.

Such a first motor M1 can then be connected to two first primary monitoring connections C12, C13 of the first simplex primary computer C1 in order to transmit to them a first monitoring signal representative of a motor state of the first motor M1. The first primary monitoring connection C13 is then connected to a first hardware monitoring building block HM1 of the first simplex primary computer C1.

A second motor M2 can be connected to a second control connection C21 of a second simplex primary computer C2 in order to be able to receive a second control signal representative of the force law to be applied to the piloting member 20.

Such a second motor M2 may also be connected to two second primary monitoring connections C22, C23 of the second simplex primary computer C2 in order to transmit to them a second monitoring signal representative of a motor state of the second motor M2.

The second primary monitoring connection C23 is then connected to a second hardware monitoring building block HM2 of the second simplex primary computer C2.

Finally, a third motor M3 can be connected at any time either to a first control connection C31 of a first simplex secondary computer C3, or to a second control connection C41 of a second simplex secondary computer C4 in order to be able to receive a third control signal representative of the force law to be applied to the piloting member 20.

The third motor M3 can then be electrically connected to a switching device 50. Such a switching device 50 is electrically connected to both the first simplex secondary computer C3 and the second simplex secondary computer C4.

As shown in more detail in FIG. 5, such a switching device 50 is further configured to connect the third motor M3 to either the first simplex secondary computer C3 or the second simplex secondary computer C4 as a function of validity signals VAL_C3, VAL_C4 generated by the first simplex secondary computer C3 and the second simplex secondary computer C4.

More specifically, the first simplex secondary computer C3 and second simplex secondary computer C4 may be self-monitored through a so-called “HM” hardware monitoring building block. Such a building block can then be simple to implement and be integrated into each of the simplex secondary computers C3, C4.

More precisely, a first secondary monitoring connection C33 is then connected to a third hardware monitoring building block HM3 of the first simplex secondary computer C3, and a second secondary monitoring connection C43 is then connected to a fourth hardware monitoring building block HM4 of the second simplex secondary computer C4.

The first simplex secondary computer C3 can then communicate a first validity signal VAL_C3 to a first switch 51 and a second switch 55 connected in series with the switching device 50.

Similarly, the second simplex secondary computer C4 can communicate a second validity signal VAL_C4 to a third switch 52 of the switching device 50.

As shown, the switching device 50 may comprise the first switch 51 and the second switch 55 connected both to a control signal CMD_C3 of the first simplex secondary computer C3 and to a validity signal VAL_C3 of the first simplex secondary computer C3, making it possible either to close the first switch 51 and the second switch 55 jointly, or to open the first switch 51 and the second switch 55 jointly.

When the first switch 51 and the second switch 55 are closed, the third motor M3 is then controlled by the control signal CMD_C3 of the first simplex secondary computer C3.

On the other hand, when the first switch 51 and/or the second switch 55 is/are open, the third motor M3 is no longer controlled by the control signal CMD_C3 of the first simplex secondary computer C3.

Moreover, the switching device 50 may comprise a third switch 52 and a fourth switch 53 connected in series to the second simplex secondary computer C4 in order to be able to receive the corresponding control signal CMD_C4.

The fourth switch 53 may be electrically connected, possibly via an inverter gate 54, to the validity signal VAL_C3 of the first simplex secondary computer C3 in order to be placed in an open or closed state as a function of the received validity signal VAL_C3.

The third switch 52 is then electrically connected to the validity signal VAL_C4 of the second simplex secondary computer C4.

Thus, when the third and fourth switches 52, 53 are closed, the third motor M3 is then controlled by the control signal CMD_C4 of the second simplex secondary computer C4.

Each switch may, for example, take the form of a relay, a MOSFET type transistor, or the like.

Moreover, the third motor M3 can be connected both to two first secondary monitoring connections C32, C33 of the first simplex secondary computer C3 and to two second secondary monitoring connections C42, C43 of the second simplex secondary computer C4 in order to be able to emit a third monitoring signal representative of a motor state of the third motor M3.

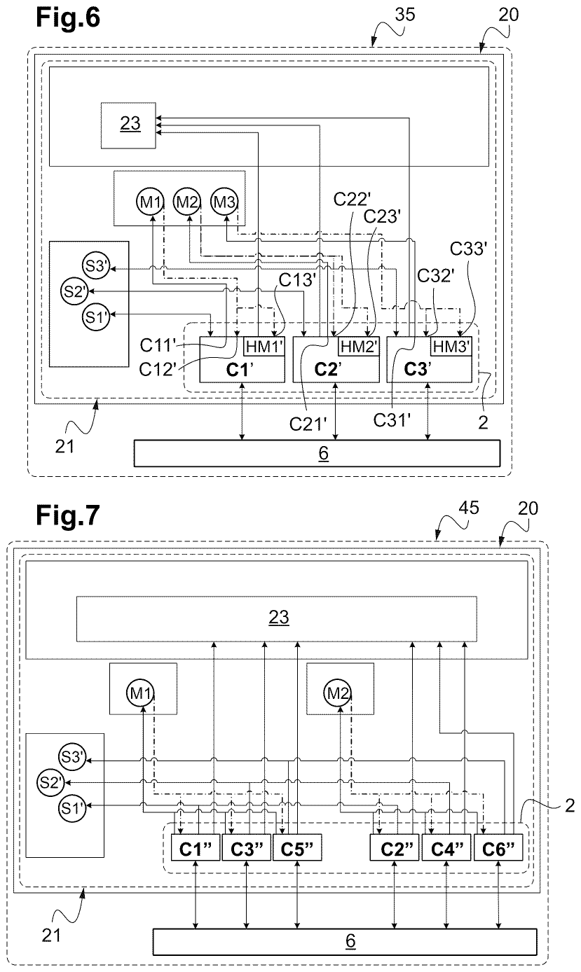

As shown in FIG. 6, the system 35 may comprise three motors M1, M2, M3 respectively connected to a simplex primary computer C1′, a simplex secondary computer C2′, and a simplex tertiary computer C3′, the simplex computers C1′, C2′, and C3′ all being dissimilar to one another.

As before, a first motor M1 can then be connected to two first primary monitoring connections C12′, C13′ of the first simplex primary computer C1′ in order to transmit to them a first monitoring signal representative of a motor state of the first motor M1. One of the two primary monitoring connections C12′, C13′ is then connected to a first hardware monitoring building block HM1′ of the simplex primary computer C1′.

Similarly, the second motor M2 may be connected to two secondary monitoring connections C22′, C23′ of the simplex secondary computer C2′ in order to transmit to them a second monitoring signal representative of a motor state of the second motor M2. One of the two secondary monitoring connections C22′, C23′ is then connected to a second hardware monitoring building block HM2′ of the simplex secondary computer C2′.

In addition, the third motor M3 may be connected at the same time to two tertiary monitoring connections C32′, C33′ of the simplex tertiary computer C3′. One of the two tertiary monitoring connections C32′, C33′ is then connected to a third hardware monitoring building block HM3′ of the simplex tertiary computer C3′.

Moreover, the system 35 may then comprise a primary position sensor S1′, a secondary position sensor S2′, and a tertiary position sensor S3′ that are all dissimilar to one another.

The primary position sensor S1′ is then electrically connected to the simplex primary computer C1′, the secondary position sensor S2′ is electrically connected to the simplex secondary computer C2′ and the tertiary position sensor S3′ is electrically connected to the simplex tertiary computer C3′.

As shown in FIG. 7, the system 45 may comprise two identical simplex primary computers C1″, C2″, two identical simplex secondary computers C3″, C4″ dissimilar to the two simplex primary computers C1″, C2″ and two identical simplex tertiary computers C5″, C6″ dissimilar to both the two simplex primary computers C1″, C2″ and the two simplex secondary computers C3″, C4″.

In this case, the primary position sensor S1′ is then electrically connected to the two simplex primary computers C1″, C2″, the secondary position sensor S2′ is electrically connected to the two simplex secondary computers C3″, C4″ and the tertiary position sensor S3′ is electrically connected to the two simplex tertiary computers C5″, C6″.

Moreover, the system 45 may comprise a first motor M1 connected at the same time to a simplex primary computer C1″, a simplex secondary computer C3″ and a simplex tertiary computer C5″, and a second motor M2 connected at the same time to a simplex primary computer C2″, a simplex secondary computer C4″ and a simplex tertiary computer C6″.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. An electrical flight control system for controlling an aircraft, the flight control system comprising at least one subassembly for acquiring a piloting command in order to acquire the piloting command from an operation of an associated piloting member that can be operated by a pilot of the aircraft along at least one piloting axis, the flight control system comprising at least three position sensors per piloting axis, each position sensor generating position information of the piloting member and being in communication with the acquisition subassembly(ies),
each acquisition subassembly comprising at least three simplex computers each having a single calculation channel connected to one of the at least three position sensors (S1, S2, S3, S4, S1′, S2′, S3′),
wherein, at least two computers among the at least three simplex computers are dissimilar and at least two position sensors among the at least three position sensors are dissimilar.

2. The system according to claim 1,
wherein the flight control system comprises at least two motors configured to jointly apply a force law to a moving part of the piloting member.

3. The system according to claim 1,
wherein the at least three simplex computers and two identical simplex secondary computers dissimilar from the two simplex primary computers.

4. The system according to claim 2, wherein the at least three simplex computers and two identical simplex secondary computers dissimilar from the two simplex primary computers and wherein the at least two motors comprise four motors, two motors being individually connected to two simplex primary computers via two control connections and two other motors being individually connected to two simplex secondary computers via two other control connections so as to be able to receive a control signal representative of the force law to be applied to the moving part of the piloting member, each motor being connected either to two primary monitoring connections of the two simplex primary computers, or to two secondary monitoring connections of the two simplex secondary computers so as to be able to emit a monitoring signal representative of a motor state.

5. The system according to claim 2, wherein the at least three simplex computers and two identical simplex secondary computers dissimilar from the two simplex primary computers and wherein the at least two motors comprise:
a first motor connected to a first control connection of a first simplex primary computer in order to be able to receive a first control signal representative of the force law to be applied to the piloting member;
a second motor connected to a second control connection of a second simplex primary computer in order to be able to receive a second control signal representative of the force law to be applied to the piloting member; and
a third motor connected on command either to a first control connection of a first simplex secondary computer, or to a second control connection of a second simplex secondary computer in order to be able to receive a third control signal representative of the force law to be applied to the piloting member.

6. The system according to claim 5,
wherein:
the first motor is connected to two first primary monitoring connections of the first simplex primary computer in order to be able to emit a first monitoring signal representative of a motor state of the first motor;
the second motor is connected to two second primary monitoring connections of the second simplex primary computer in order to be able to emit a second monitoring signal representative of a motor state of the second motor; and
the third motor is connected both to two first secondary monitoring connections of the first simplex secondary computer and to two second secondary monitoring connections of the second simplex secondary computer in order to be able to emit a third monitoring signal representative of a motor state of the third motor.

7. The system according to claim 5,
wherein the third motor is electrically connected to a switching device, the switching device being electrically connected to the first simplex secondary computer and to the second simplex secondary computer and being configured to connect the third motor either to the first simplex secondary computer or to the second simplex secondary computer, the first simplex secondary computer and the second simplex secondary computer being self-monitored and communicating a first validity signal and a second validity signal respectively, firstly, to a first switch and a second switch connected in series and, secondly, to a third switch and a fourth switch connected in series with the switching device.

8. The system according to claim 1,
wherein the at least three position sensors comprise two identical primary position sensors and two identical secondary position sensors dissimilar to the two primary position sensors.

9. The system according to claim 2,
wherein the at least three simplex computers comprise a simplex primary computer, a simplex secondary computer and a simplex tertiary computer, all dissimilar to one another.

10. The system according to claim 2,
wherein the at least three simplex computers comprise two identical simplex primary computers, two identical simplex secondary computers, dissimilar to the two simplex primary computers and two identical simplex tertiary computers that are dissimilar to both the two simplex primary computers and the two simplex secondary computers.

11. The system according to claim 9,
wherein the at least three position sensors comprise a primary position sensor, a secondary position sensor dissimilar to the primary position sensor and a tertiary position sensor that is dissimilar to both the primary position sensor and the secondary position sensor.

12. The system according to claim 1,
wherein the acquisition subassembly(ies) is/are incorporated in the piloting member.

13. An aircraft provided with the electrical flight control system for controlling the aircraft,
wherein the flight control system is according to claim 1.
